(19) United States
(12) Patent Application Publication
(10) Pub. No.: US 2023/0177558 A1
(43) Pub. Date: Jun. 8, 2023

(54) METHOD AND SYSTEM FOR PREDICTING A KEY PERFORMANCE INDICATOR (KPI) OF AN ADVERTISING CAMPAIGN

(71) Applicant: KENSHOO LTD., Tel Aviv (IL)

(72) Inventors: Yonatan REPPEN, Tel Aviv (IL); Itai BLITZER, Ramat Gan (IL)

(21) Appl. No.: 18/075,705

(22) Filed: Dec. 6, 2022

Related U.S. Application Data
(60) Provisional application No. 63/286,127, filed on Dec. 6, 2021.

(51) Int. Cl. G06Q 30/0242; G06Q 10/0639

(52) U.S. Cl. CPC G06Q 30/0242; G06Q 10/06393

(57) ABSTRACT

A system and method of predicting a value of a key performance indicator (KPI) of a target advertisement campaign may include receiving a plurality of campaign data elements, such as campaign types, campaign geographies, campaign dates, and historic KPI values corresponding to a respective plurality of campaigns; processing the plurality of campaign data elements to produce one or more training batches; training a machine-learning (ML) model to predict a value of a campaign KPI, based on the one or more training batches. In a subsequent inference stage, embodiments may receive at least one new campaign data element, corresponding to a target campaign; and applying the trained ML model on the at least one new campaign data element to predict a value of a target KPI of the target campaign.

### CROSS-REFERENCE TO RELATED APPLICATIONS

This application claims the benefit of U.S. Provisional Patent Application No. 63/286,127, filed Dec. 6, 2021, entitled “METHOD AND SYSTEM FOR PREDICTING A KEY PERFORMANCE INDICATOR (KPI) OF AN ADVERTISING CAMPAIGN” which is hereby incorporated by reference in its entirety.

### FIELD OF THE INVENTION

The present invention relates generally to artificial intelligence technology. More specifically, the present invention relates to using predicting a value of a key performance indicator (KPI) of an advertisement campaign.

### BACKGROUND OF THE INVENTION

In the art of Natural Language Processing (NLP) the meaning of a word may be represented in a data structure commonly referred to as an embedding vector. A difference metric (e.g., a cosine metric) may be defined between two vectors (representing respective words), to identify similarity in meaning or context between the underlying words. A machine-learning (ML) or Artificial Intelligence (AI) model may then be trained to understand context and relationships between words represented by the embedding vectors.

This approach has been practiced for facilitating training of ML models to understand natural (e.g., human spoken) languages, generate sentences and use pre-trained networks to solve related problems. For example, a pre-trained transformer model, such as the currently available Bidirectional Encoder Representations from Transformers (BERT) model is trained to perform NLP tasks (e.g., masking, next sentence classification, etc.), it may be further utilized for down-stream tasks, whether by using the embedding vector representations as are, or after fine-tuning them.

In the world of digital advertising, an advertiser may be interested in learning how their objectives (e.g., sales, revenue, or other business Key Performance Indicators (KPIs)) may change over time, or in in response to a change in their advertisement strategy.

The terms “campaign” and “advertisement campaign” may be used herein interchangeably, to indicate implementation of an advertisement strategy, in one or more advertisement platforms, in effort to advertise or promote a specific product or service.

The terms “strategy” and “advertisement strategy” may be used herein interchangeably to refer to a data structure that may include definition of a plurality of data elements pertaining to advertisement of an underlying service or a product by an advertiser.

For example, an advertisement strategy may define or dictate a mixture of one or more different channels or platforms of advertisement (e.g., Facebook, Google, YouTube, Instagram, television, radio, offline commercials, and the like).

In another example, an advertisement strategy may include a selection or a definition of a target audience (e.g., by determining a target gender, a target age, a target group of people sharing common interests, a target geographical locality or ethnicity, and the like).

In another example, an advertisement strategy may include a selection of timing of an advertisement campaign (e.g., over a predefined period of time, such as around a season or holidays, around special events, and the like).

In another example, an advertisement strategy may include a selection of a type of advertisements (e.g., printed advertisements, advertisement videos, advertisement audio streams, and the like).

In another example, an advertisement strategy may include definition of content that may be used in the advertisements. This definition of content may include, for example specific words or slogans used, specific representors of the underlying product or service, and the like.

In another example, an advertisement strategy may include definition of expenditure that may be spent in the advertisement campaign, including for example expenditure on each advertisement channel, expenditure on each target audience, and the like.

It may be appreciated that the variety of combinations of different elements included in the advertisement strategy may be extremely large. Thus, the effectiveness of a change, made in any specific element of an advertisement campaign on a predefined set of KPIs is very difficult to assess.

### SUMMARY OF THE INVENTION

Currently available methods of analyzing this information may use an AB test schema, randomized experiments, and statistical inference tools to answer this question. However, it may be appreciated that KPIs (e.g., sales indicators, revenue indicators, etc.) of one advertiser may be related or predicted by similar data pertaining to other advertisers. Additionally, or alternatively, KPIs of an advertisement campaign pertaining to a first product or service, and performed in a first geographical location may be related to KPIs of other advertisement campaigns, pertaining to other products, and performed in other geographical locations. Currently available methods of analyzing effectiveness of advertisement strategy elements may not provide insight on a first advertisement campaign, based on data derived from different advertisement campaigns, different advertisers and/or different underlying advertised products and services.

Embodiments of the invention may include a method of predicting, by at least one processor, a value of a key performance indicator (KPI) of a target advertisement campaign. Embodiments of the method may include receiving a plurality of first campaign data elements, corresponding to a respective plurality of campaigns. The first campaign data elements may be selected from a list consisting of a campaign type, a campaign geography, a campaign date, and a historic campaign KPI value. Embodiments of the method may further include processing the plurality of first campaign data elements, to produce one or more training batches, where each training batch may include information that is derived from campaigns having at least one of: a different campaign type, a different geography, and a different date.

Embodiments of the method may further include training a machine-learning (ML) model to predict a value of a campaign KPI, based on the one or more training batches; receiving at least one second campaign data element, corresponding to a target campaign; and applying the trained ML model on the at least one second campaign data element to predict a value of a target KPI of the target campaign.

According to some embodiments of the invention, producing a training batch of the one or more training batches may include: processing the plurality of first campaign data elements to create a plurality of image data structures, wherein each image data structure pertains to a specific base campaign of the plurality of campaigns; selecting a subset of the plurality of image data structures; and concatenating the selected subset of image data structures to create the training batch.

According to some embodiments of the invention, selecting the subset of image data structures may include performing combinatorial selection of a subset of the plurality of image data structures, such that each image data structure of the subset has a base campaign that corresponds to a unique campaign type.

According to some embodiments of the invention, the image data structure may represent a correlation between a KPI value of the base campaign and a KPI value of one or more other campaigns (e.g., auxiliary campaigns) of the plurality of campaigns.

Additionally, or alternatively, creating an image data structure of the plurality of image data structures may include: processing one or more campaign data elements of the plurality of first campaign data elements, pertaining to a base campaign of the plurality of campaigns, to create a campaign embedding vector, representing a content or subject of the base campaign; processing one or more campaign data elements of the plurality of first campaign data elements, pertaining to one or more other campaigns of the plurality of campaigns, to calculate one or more auxiliary information data elements, representing one or more other campaigns of the plurality of campaigns; and creating an image data structure that may include the campaign embedding vector and the one or more auxiliary information data elements.

Additionally, or alternatively, one or more (e.g., each) campaign may be associated with a respective campaign identifier (ID), and one or more (e.g., each) campaign may be associated with a campaign performance metric value. In such embodiments, calculating an auxiliary information data element may include grouping the plurality of campaigns based on their respective combination of geography and date; sorting each group of campaigns based on their respective campaign performance metric values, to obtain a plurality of sorted vectors of campaign IDs; and applying an embedding ML model on at least one sorted vector of campaign IDs, to obtain at least one respective auxiliary information data element, that represents an embedding of performance metric values of the relevant group of campaigns.

According to some embodiments, the plurality of first campaign data elements may include a plurality of geography data elements, representing a geography of a respective plurality of campaigns. In such embodiments, calculating an auxiliary information data element may include receiving a first version of a demographic data element corresponding to a geography data element of the plurality of geography data elements, where the first version of the demographic data element is characterized by a first representation dimension; and applying an ML module on the geography data element, to obtain an auxiliary information data element that is a second version of the geography data element, having a second, reduced representation dimension.

Additionally, or alternatively, embodiments of the method may include applying a plurality of permutations on the campaign data elements; applying the trained ML model on the permutated campaign data elements, to simulate outcome target KPI values corresponding to the permutated campaign data elements; and analyzing the outcome of KPI predictions, in view of the permutated campaign data elements, to produce a suggested campaign properties data structure. This suggested campaign properties data structure may represent optimal campaign data elements in relation to a target KPI.

Additionally, or alternatively, the permutations may include, for example permutations or changes in campaign properties, advertiser identification, campaign types, campaign characteristics, campaign geography, target population, campaign date, campaign advertisement properties, advertisement type, advertisement platform, advertisement content, and/or advertisement text content.

Embodiments of the invention may include a system for predicting a value of a key performance indicator (KPI) of a target advertisement campaign. Embodiments of the system may include a non-transitory memory device, where modules of instruction code may be stored, and at least one processor associated with the memory device, and configured to execute the modules of instruction code.

Upon execution of said modules of instruction code, the at least one processor may be configured to: receive a plurality of first campaign data elements, corresponding to a respective plurality of campaigns, said first campaign data elements may be selected from a list consisting of a campaign type, a geography, a date, and a historic KPI value; process the plurality of first campaign data elements, to produce one or more training batches, wherein each training batch may include information that may be derived from campaigns having at least one of: a different campaign type, a different geography, and a different date; train a machine-learning (ML) model to predict a value of a campaign KPI, based on the one or more training batches; receive at least one second campaign data element, corresponding to a target campaign; and apply the trained ML model on the at least one second campaign data element to predict a value of a target KPI of the target campaign.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for predicting a value of a KPI of an advertisement campaign, according to some embodiments; and

FIG. 2 is a block diagram depicting a system for predicting a value of a KPI of an advertisement campaign, according to some embodiments of the invention;

FIG. 3 is a block diagram depicting functionality of a preprocessing module which may be included in a system for predicting a value of a KPI of an advertisement campaign, according to some embodiments of the invention;

FIG. 4, which is a table depicting non-limiting example of an image data structure, which may be produced by a system for predicting a value of a KPI of an advertisement campaign, according to some embodiments of the invention; and

FIG. 5 is a flow diagram, depicting a method of predicting, by at least one processor, a value of a KPI of an advertisement campaign, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

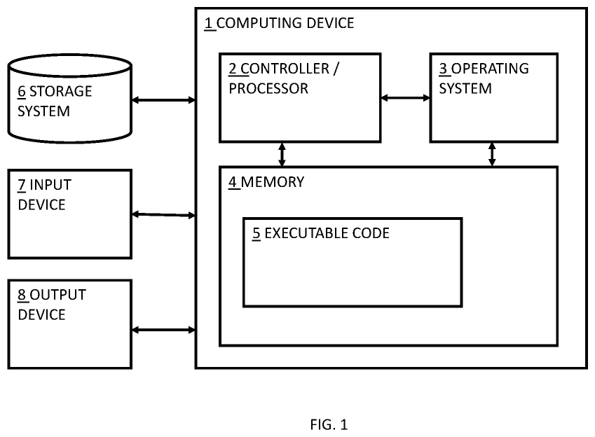

Reference is now made to FIG. 1, which is a block diagram depicting a computing device, which may be included within an embodiment of a system for predicting a value of a KPI of an advertisement campaign, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may predict a value of a KPI of an advertisement campaign as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to, or representing one or more advertisement campaigns may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse, and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

A neural network (NN) or an artificial neural network (ANN), e.g., a neural network implementing a machine learning (ML) or artificial intelligence (AI) function, may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g., CPUs or graphics processing units (GPUs), or a dedicated hardware device may perform the relevant calculations.

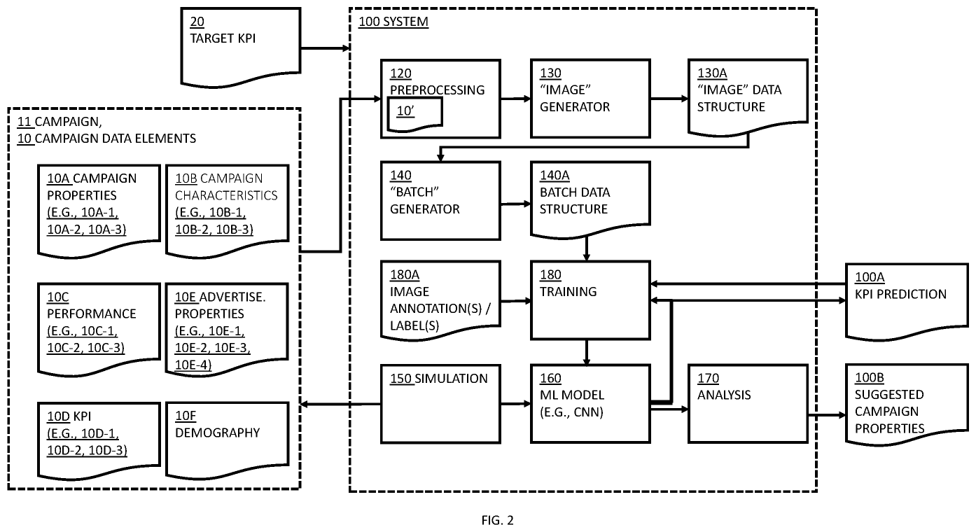

Reference is now made to FIG. 2, which is a block diagram depicting a system for predicting a value of a KPI of an advertisement campaign 11, according to some embodiments of the invention.

According to some embodiments of the invention, system 100 may be implemented as a software module, a hardware module, or any combination thereof. For example, system may be, or may include a computing device such as element 1 of FIG. 1, and may be adapted to execute one or more modules of executable code (e.g., element 5 of FIG. 1) to predict a value of a target KPI 20 of an advertisement campaign 11, as further described herein.

As shown in FIG. 2, arrows may represent flow of one or more data elements to, and/or from system 100 and/or among modules or elements of system 100. Some arrows have been omitted in FIG. 2 for the purpose of clarity.

According to some embodiments, system 100 may be configured to receive an identification of a target KPI 20. Target KPI 20 identification may, for example representing one or more KPI indications that an advertiser would want to study or predict in relation to a specific campaign 11, also referred to herein as a “target” campaign 11. For example, target KPI 20 may refer to an indication of an overall revenue, or number of sales in a specific geography or date of the target campaign 11. In another example, target KPI 20 may refer to an indication of an action taken by a target audience of the target campaign 11, such as placing a donation, participation in a survey, placing of a purchase order, etc.

According to some embodiments, system 100 may subsequently produce one or more predicted values 100A of the one or more respective target KPIs 20 (e.g., sales indicators, revenue indicators or other business KPIs), of a specific campaign 11 (e.g., for a specific product or service). System 100 may do so based on a context of digital advertisement campaigns 11 of other products, services, and/or advertisers, as elaborated herein.

As elaborated herein, system 100 may include an ML-based model 160, that may be, or may include a deep learning model (e.g., a deep neural network (DNN) model), based on convolutional neural network (CNN) layers. As elaborated herein, ML model 160 may be configured to learn, or model relationships between different advertisement campaigns 11.

Embodiments of the invention may utilize the unique properties of CNN layers, such as sparse representation and feature extraction, to model the relationships between different advertisement campaigns 11, to produce prediction 100A.

According to some embodiments, system 100 may receive (e.g., from input device 7 of FIG. 1) a plurality of campaign data elements 10, corresponding to a respective plurality of advertisement campaigns. As elaborated herein, system 100 may be configured to build a flexible ML model 160 that may produce a prediction of KPI 100A based on the input campaign data elements 10. Additionally, system 100 may be configured to predict the effect of changes in the digital world on each instance of an advertisement campaign 11, pertaining to any advertiser, or product.

For example, campaign data elements 10 of an advertisement campaign 11 may include one or more campaign properties 10A, such as a campaign identification (ID) 10A-1, an advertiser identification (ID) 10A-2, and a campaign type 10A-3 (e.g., an identification or description of an underlying, advertised product or service).

In another example, campaign data elements 10 may include one or more campaign characteristics 10B such as a geography 10B-1 (e.g., a geographical area, such as a city or a state, a Designated Market Area (DMA), a zip code, and the like), a target population 10B-2 (e.g., males, females, age range, and the like), and a campaign date 10B-3.

In another example, campaign data elements 10 may include campaign performance data elements 10C. For example, a campaign advertisement may be presented as a web page (e.g., via a web browser) on a plurality of computing devices pertaining to a respective plurality of users. System 100 may obtain (e.g., via the plurality of web browsers) campaign performance data elements 10C pertaining to the presentation of the advertisements on the users' computing devices. Such performance data elements 10C may include, for example mouse clicks 10C-1, impressions 10C-2 and cost 10C-3 obtained from the users.

In another example, campaign data elements 10 may include historic campaign KPI data 10D, such as sales indicators 10D-1, revenue indicators 10D-2, and the like.

In another example, campaign data elements 10 may include data representing advertisement properties 10E, such as an identification of an advertisement type 10E-1 (e.g., online advertisement, television advertisement, radio advertisement, etc.), identification of an advertisement platform 10E-2 (e.g., for online advertisement types 10E-1, this may be an identification of online advertisement platforms, such as Google Ads, Facebook, Instagram, and the like), a visual content of an advertisement 10E-3 of the campaign 11 (e.g., an identification or description of an image in the advertisement), a textual content of an advertisement 10E-4 of the campaign 11, and the like.

In yet another example, campaign data elements 10 may include data representing demographic, or census information 10F. Demographic data 10F may include, for example demographic information pertaining to one or more geographies 10B-1, including for example a socio-economic condition of one or more households, a number of children per household, a number of people in each age range, a number of people of each gender in a household, and the like.

According to some embodiments, system 100 may include an input preprocessing module 120, configured to preprocess the various input campaign data elements 10 to produce a second version of the campaign data elements 10, as elaborated herein.

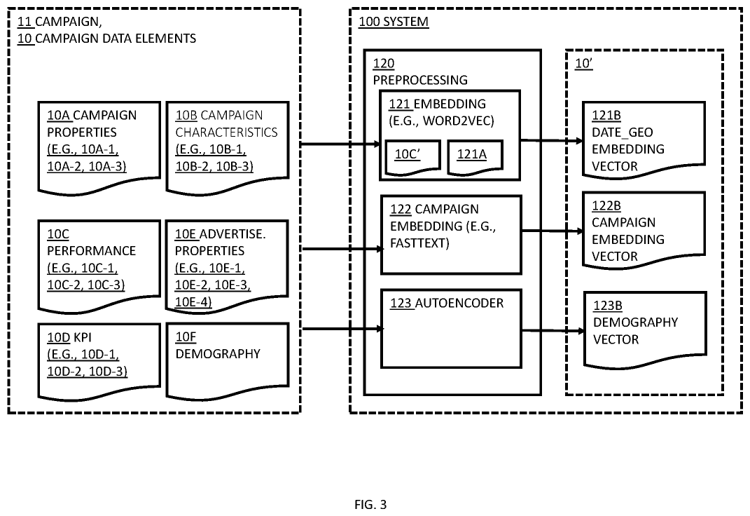

Reference is now also made to FIG. 3 which is a block diagram depicting functionality of a preprocessing module 120 which may be included system 100 for predicting a value of a KPI of an advertisement campaign 11, according to some embodiments of the invention.

According to some embodiments, preprocessing module 120 may include a first embedding module 121, configured to receive campaign data elements 10, and produce therefrom a second version, or representation of campaign data elements 10′, denoted herein as embedding vectors 121B.

For example, embedding module 121 may receive an identification of one or more historical campaigns 10A-1, and corresponding one or more geographies 10B-1, campaign dates 10B-3, and one or more performance data elements 10C (e.g., mouse clicks 10C-1, impressions 10C-2, and cost 10C-3). For one or more (e.g., each) campaign ID 10A-1, embedding module 121 may calculate a performance metric 10C′ based on the one or more performance data elements 10C.

As elaborated herein, one or more (e.g., each) campaign 11 of the plurality of advertisement campaigns 11 may have, or may be associated with a campaign ID 10A-1.

Additionally, one or more (e.g., each) campaign 11 of the plurality of advertisement campaigns 11 may be associated with at least one campaign performance metric value 10C′. For example, each campaign 11 may include, or may be characterized by at least one campaign data element 10 that is a performance data element 10C (e.g., mouse clicks 10C-1, impressions 10C-2, and cost 10C-3). Embedding module 121 may calculate at least one performance metric value 10C′ based on the performance data element 10C. The at least one performance metric value 10C′ may thus be referred to herein as associated with the relevant campaign 11.

According to some embodiments, embedding module 121 may calculate performance metric value 10C′ of an advertisement campaign 11 as a weighted sum of a plurality of performance data elements 10C (e.g., a weighted sum of mouse clicks 10C-1, impressions 10C-2, and cost 10C-3) of the campaign 11. In another example, the at least one performance metric value 10C′ may be equal to at least one respective performance data elements 10C of the campaign 11.

According to some embodiments, embedding module 121 may group the plurality of campaigns 11 based on their respective combination of geography 10B-1 and date 10B-3. In other words, for each unique combination of a campaign geography 10B-1 and campaign dates 10B-3, embedding module 121 may produce a list of active campaign IDs 10A-1. The term “active” may be used herein to indicate campaigns 11 in which the performance data elements 10C is not zero. Embedding module 121 may then sort each list or group of campaigns 11 by the at least one calculated performance metric 10C′, e.g., from the highest performance metric value to the lowest performance metric value 10C′. Embedding module 121 may thus obtain a plurality of sorted vectors or lists of campaign IDs 10A-1. These lists or vectors of sorted campaign IDs 10A-1 may be referred to herein as date_geo strings 121A.

For example, given a plurality of campaigns 11, corresponding to campaign IDs C1, C4, C8, and C50, in the dates of January 01, and January 02, in the geographies of New York and Los Angeles, embedding module 121 may produce a list of sorted date_geo strings 121A, as elaborated in Table 1, below:

TABLE 1

| Geography 10B-1 | Date | Date_geo ID | Date_geo strings |
|---|---|---|---|
| January 1 | New York | 1.1_NY | [C1, C4, C50] |
| January 1 | New York | 2.1_NY | [C50, C8, C1] |
| January 2 | Los Angeles | 1.1_LA | [C1, C50, C4] |

According to some embodiments, embedding module 121 may include an embedding model 121′, configured to receive the one or more date_geo strings 121A, and represent the one or more date_geo strings 121A by corresponding date_geo embedding vectors 121B.

For example, embedding model 121′ may include an ML-based model such as a word2vec model.

As known in the art, a word2vec model may receive as input a text corpus, and produce therefrom a set of feature vectors that represent words in that corpus. A word2vec model may thus turn text into a numerical format that deep neural networks (DNNs) may understand. According to some embodiments, embedding model 121′ (e.g., word2vec model), may be trained, or may be configured to produce embedding vectors 121B that represent similarity among date_geo strings 121A.

In other words, embedding module 121 may receive a first version of one or more input campaign data 10, and produce therefrom a second version 10′ of the one or more input campaign data 10′ (e.g., the date_geo embedding vectors 121B), representing relations of similarity (or dissimilarity) between different combinations of campaign geography 10B-1 and campaign date 10B-3 in terms of performance metrics.

In other words, system 100 may apply embedding ML model 121 on at least one sorted vector of campaign IDs 10A-1, to obtain at least one respective auxiliary information data element 130B, that represents an embedding of performance metric values 10C′ of the relevant group of campaigns 11.

In the example of table 1, the embedding vectors 121B corresponding to the date_geo strings 121A of Table 1 may reflect similarity of campaigns 11 in New York and Los Angeles, on the respective dates, in terms of how well campaigns 11 C1,C50 and C4 perform there.

According to some embodiments, preprocessing module 120 may include a second embedding module 122, configured to receive campaign data elements 10, and produce therefrom a second version, or representation of campaign data elements 10′, denoted herein as embedding vectors 122B.

For example, embedding module 122 may receive an identification (ID) of one or more historical campaigns 10A-1, and corresponding one or more textual campaign data elements 10 associated with, or describing each historical campaign (e.g., denoted by ID 10A-1).

For example, the one or more textual campaign data elements 10 may include a campaign type 10A-3 (e.g., an identification or description of an underlying, advertised product or service). Additionally, or alternatively, the one or more textual campaign data elements 10 may include advertisement properties' data elements 10E such as a textual content or description of an advertisement 10E-4 of the campaign 11. Such textual content may include, for example textual data elements such as free text representing an advertised product or service, a title of an advertisement web page, a keyword included in the advertisement, search terms included in the advertisement, a URL line defining an advertisement, and the like. Additionally, or alternatively, the one or more textual campaign data elements 10 may include an identification of an advertisement type 10E-1, an identification of an advertisement platform 10E-2, a description or identification of visual content of an advertisement 10E-3 of the campaign 11, and the like.

According to some embodiments, embedding module 122 may include an embedding model 122′, configured to receive the one or more textual campaign data elements 10 (e.g., as elaborated above), and apply an embedding algorithm on the textual campaign data elements 10, so as to represent the textual campaign data elements 10 by corresponding embedding vectors 122B.

For example, embedding model 122′ may be a FastText model. As known in the art, a FastText model may include a library for efficient learning of word vectoral representations and sentence classification. According to some embodiments, embedding model 122′ may include a pre-trained FastText model, and may be specifically configured (e.g., by fine-tuning one or more hyper parameters, as known in the art) to facilitate production of embedding vectors 122B. Embedding model 122′ may thus be adapted receive textual campaign data elements 10 pertaining to specific campaigns 11, and produce therefrom campaign embedding vectors 122B. It may be appreciated by a person skilled in the art that a distance metric (e.g., a cosine distance metric) between campaign embedding vectors 122B may represent relations of similarity (or dissimilarity) between the different campaigns 11. In other words, embedding vectors 122B may be regarded as representing a subject and content of advertisements in a specific campaign 11 (e.g., the underlying advertised product or service, the method of advertisement, description of text and/or images included in the advertisements, etc.).

According to some embodiments, embedding model 122′ may process one or more campaign data elements 10 of the plurality of campaign data elements 10, pertaining to a base campaign 11 of the plurality of campaigns 11. Embedding model 122′ may thus create a campaign embedding vector 122B representing a content or subject of the base campaign 11 (denoted by a unique campaign ID 10A-1).

As elaborated herein, demographic data 10F may include a plurality of data elements that may describe or represent (e.g., in textual or numerical format) demographic information pertaining to, or corresponding to one or more geographies 10B-1.

According to some embodiments, preprocessing module 120 may receiving a first version of a demographic data element 10F corresponding to a geography data element 10B-1 of the plurality of geography data elements. This first version of the demographic data element 10F may be a data structure (e.g., a vector of data elements that may have, or may be characterized by a first representation dimension. Preprocessing module 120 may include a ML-based module such as an autoencoder 123. Preprocessing module 120 may apply ML module 123 on the geography data element 10F of the first version, to obtain an auxiliary information data element 130B that is a second version of the geography data element 10F. The auxiliary information data element 130B may have, of may be characterized by a second, reduced representation dimension.

For example, autoencoder 123 may be configured to receive demographic campaign data 10F (e.g., the at least one demographic information data elements) pertaining to a specific geography 10B-1, and produce therefrom a vectoral representation 123B (denoted “demography vector” or “geography-specific demography vector”) of the demographic campaign data 10F. It may be appreciated by a person skilled in the art that autoencoder 123 may reduce a size or dimension of the demographic campaign data 10F, to produce a demography vector 123B that is (a) compressed in size in relation to demographic data 10F, and yet (b) represents the demographic data 10F of one or more specific geographies 10B-1 in a compressed, reconstructible (e.g., maintaining the same information) format.

Referring back to FIG. 2, system 100 may include an image generator module 130, configured to organize the campaign data elements 10 and/or the preprocessed version 10′ of campaign data elements 10, to produce at least one data structure that may be referred to herein as an “image” data structure 130A.

According to some embodiments, image data structure 130A may uniquely represent a combination of a specific campaign 11 (e.g., a specific campaign ID 10A-1), a specific date in which the specific campaign 11 (ID 10A-1) was performed, and a specific target KPI 20 (e.g., a sales indicator, a revenue indicator, an action taken by a target audience and/or another business KPI) of campaign ID 10A-1.

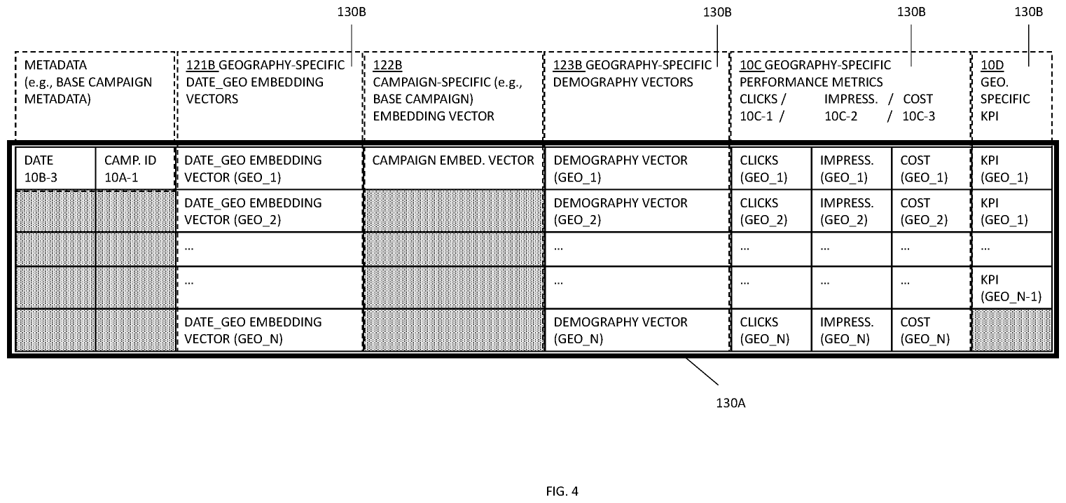

Reference is now made to FIG. 4, which is a table depicting non-limiting example of an image data structure, which may be produced by a system for predicting a value of a KPI of an advertisement campaign 11, according to some embodiments of the invention.

As depicted in the example of FIG. 4, image generator module 130 may produce image data structure 130A as a combination of campaign data elements 10 and preprocessed campaign data elements 10′.

As elaborated herein, each image data structure 130A may pertain to, or represent a specific campaign 11 (represented by a respective campaign ID 10A-1), which may be referred to herein as a “base” campaign 11, and may be associated with a specific date 10B-3, a specific geography 10B-1, and/or a specific target KPI 20.

During a training stage, system 100 may utilize a plurality of such image data structures 130A to train an ML model (ML model 160 of FIG. 2), so as to predict a value 100A of a predefined KPI 20. As elaborated herein, ML model 160 may be, or may include a CNN network.

It may be appreciated by a person skilled in the art that an ML model 160 that is a CNN model may provide a plurality of inherent benefits for the analysis of input that is formatted as an image (e.g., image data structures 130A). This includes, for example benefits in sparse representation and feature extraction, during both a stage of training ML model 160 and an inference stage, in which ML model 160 may be applied on incoming image data structures 130A. Therefore, a CNN ML model 160 may be optimally adapted to utilize these benefits, to model the relationships between different advertisement campaigns 11 represented by an input image data structure 130A, to produce prediction 100A.

In a subsequent inference stage, system 100 may utilized trained ML model 160 to predict a value 100A of a predefined target KPI 20, in relation to a specific campaign 11, which may be referred to herein as a “target” campaign 11. In other words, during an inference stage system 100 may apply trained ML model 160 on a combination or sample (as commonly referred to in the art) of campaign data elements 10 and/or processed campaign data elements 10′ (such as a target campaign ID 10A-1, target geography 10B-1, target date 10B-3, etc.) to produce a prediction 100A of a value of a target KPI 20.

As elaborated herein, each image data structure 130A may include data pertaining to a relevant, specific base campaign 11 (represented by specific campaign ID 10A-1). Additionally, each image data structure 130A may include carefully selected information relating to other campaigns 11 (e.g., other than the base campaign 11), and represented by other campaign IDs 10A-1. This carefully selected information may be referred to herein as “auxiliary campaign information” or “auxiliary information”, and may be associated with other (e.g., other than the base campaign 11) campaign properties 10A (e.g., campaign types 10A-3), other campaign characteristics 10B (e.g., geographies 10B-1), other advertisement properties 10E, and/or other demographics 10F.

It may be appreciated by a person skilled in the art that this combination of base campaign 11 data and auxiliary campaign 11 information in image data structure 130A may allow ML model 160 to learn implicit correlations between properties of the base campaign 11 and seemingly unrelated, other campaigns 11. It may be appreciated by a person skilled in the art that the learnt correlations may then be utilized by system 100 in an inference stage to produce a predicted value 100A of a target KPI 20 for a specific target campaign 11.

In other words, each image data structure 130A my represent a correlation between a KPI value 10D of the base campaign 11 (e.g., campaign ID 10A-1) and a KPI value of one or more other campaigns 11 of the plurality of campaigns 11.

According to some embodiments, and as shown in FIG. 4, each image data structure 130A may pertain to a specific base campaign 11 in a sense that it may: (a) include a metadata representation of the base campaign ID 10A-1, and/or (b) include a campaign 11 —specific embedding vector 122B of the base campaign 11.

Additionally, or alternatively, and as shown in FIG. 4, each image data structure 130A may pertain to a specific date of the base campaign 11, in a sense that it may include a metadata representation of a specific date 10B-3 of the base campaign 11.

According to some embodiments, system 100 may process one or more campaign data elements 10 of the plurality of campaign data elements 10, pertaining to one or more campaigns 11 other than the base campaign 11. System 100 may thus calculate or produce one or more auxiliary information data elements 130B, representing the one or more campaigns 11 other than the base campaign 11.

In other words, each image data structure 130A may further include auxiliary information 130B pertaining to a plurality of campaigns 11 other than the base campaign 11. Such auxiliary information 130B may include, for example campaign geographies 10B-1 (e.g., other than the geography of the base campaign 11), campaign types 10A-3 (e.g., other than the type of the base campaign 11) and/or campaign dates 10B-3 (e.g., other than the date of the base campaign 11). As shown in the non-limiting example of FIG. 4, each image data structure 130A may include a plurality of N (e.g., 15) rows, where each row of image data structure 130A may pertain to a specific date_geo string 121A (e.g., as elaborated in the example of Table 1).

For example, as elaborated herein (e.g., in relation to FIG. 3), date_geo embedding vectors 121B may be associated with, or originate from date_geo strings 121A, in a sense that date_geo embedding vectors 121B may be an embedded vector representation of date_geo strings 121A (e.g., as in Table 1). As shown in FIG. 4, image data structure 130A may include auxiliary information 130B such as a plurality of N date_geo embedding vectors 121B, that may originate from the relevant N date_geo strings 121A, and may pertain to the same date as date 10B-3 of the base campaign 11.

Additionally, or alternatively, as shown in the example of Table 1, each date_geo strings 121A may correspond to a specific geography 10B-1 (e.g., New York, Los Angeles, etc.). Image data structure 130A may include auxiliary information 130B such as a plurality of N geography-specific demography vectors 123B, corresponding to the specific geographies 10B-1 of the respective N date_geo strings 121A.

Additionally, or alternatively, image data structure 130A may include auxiliary information 130B such as a plurality of N geography and date specific performance metric values 10C (e.g., clicks 10C-1, impressions 10C-2 and cost 10C-3) corresponding to each of the respective N date_geo strings 121A.

Additionally, or alternatively, image data structure 130A may include auxiliary information 130B such as a plurality (e.g., N-1) of KPI values 10D that are associated with respective (N−1) date_geo strings 121A of the plurality of N date_geo strings 121A. Pertaining to the example of Table 1, KPI values 10D of image data structure 130A may include (N−1) values of KPI (e.g., value of revenue) corresponding to campaigns 11 (e.g., C1, C4, C8 and C50) of (N−1) date_geo strings 121A (e.g., 1.1_NY and 2.1_NY). According to some embodiments, the (N−1) campaigns 11 corresponding to KPI values 10D of image data structure 130A may not include the base campaign 11 (e.g., represented by campaign ID 10A-1).

According to some embodiments, image generator module 130 may produce a plurality of image data structures 130A (e.g., one or more image data structures 130A for each base campaign ID).

For example, for each base campaign ID 10A-1, image generator module 130 may: (a) produce a campaign 11 —specific embedding vector 122B, and (b) select a plurality of combinations of campaign data elements 10. For each such combination, image generator module 130 may (a) compile auxiliary information 130B as elaborated above, and (b) combine base campaign 11 metadata (e.g., 10A-1, 10B-3) and base campaign 11 embedding vector 122B with the compiled auxiliary information 130B, to produce an image data structure 130A, as depicted in the example of FIG. 4.

According to some embodiments, image generator module 130 may store the plurality of image data structures 130A in a database or a repository, such as storage 6 of FIG. 1.

Referring back to FIG. 2, according to some embodiments, system 100 may include a batch generator module 140, configured to process one or more (e.g., a plurality of) campaign data elements 10 in one or more image data structures 130A, and produce one or more (e.g., a plurality of) training batch data structures 140A.

According to some embodiments, for each training batch data structure 140A, batch generator module 140 may select a subset or a predefined number of image data structures 130A from the generated image data structures 130A (e.g., in the repository of image data structures 130A). Batch generator module 140 may perform this selection randomly, under predefined constraints.

For example, batch generator module 140 may select the subset of image data structures 130A under the constraint of including, in each batch data structure 140A, information that is derived from advertisement campaigns 11 having at least one of: (a) a different campaign type 10A-3, (b) a different geography 10B-1, and (c) a different date 10B-3. Batch generator module 140 may then produce each training batch data structure 140A as a combination, or concatenation of the selected subset of image data structures 130A.

Additionally, or alternatively, batch generator module 140 may produce a plurality of training batch data structures 140A, such that each training batch data structure 140A may include at least one image data structure 130A pertaining to each campaign type 10A-3.

For example, batch generator module 140 may include, in each training batch data structure 140A, a single image data structure 130A that corresponds to a base campaign 11 having a unique campaign type 10A-3.

For example, campaigns 11 C1 and C2 may represent advertisement campaigns 11 of bathing suits (e.g., type 10A-3=“bathing suit”), campaigns 11 C3 and C4 may represent advertisement campaigns 11 of cars (e.g., type 10A-3=“car”), and campaigns 11 C5 and C6 may represent advertisement campaigns 11 of hotel services (e.g., type 10A-3=“hotel”). In such embodiments, image generator module 130 may produce a plurality (e.g., 6 or more) of unique image data structures 130A as a combinatoric combination of campaign-specific data elements 10/10′, where each image data structures 130A represents, or pertains to a specific base campaign 11 (e.g., C1), and includes auxiliary information 130B of other campaigns 11 (e.g., C2-C6), as depicted in the example of FIG. 4.

Batch generator module 140 may proceed to produce a plurality of training batch data structures 140A as elaborated herein, by performing combinatorial selections of subsets of image data structures 130A from the repository of image data structures 130A. Each subset of image data structures 130A may include a single selected combination of image data structures 130A. Batch generator module 140 may then compile or concatenate each selected subset or group of image data structures 130A to form a training batch data structure 140A.

Additionally, or alternatively, batch generator module 140 may select the subset of image data structures 130A by performing combinatorial selection of a subset of the plurality of image data structures in the repository, such that each image data structure 130A of the subset has a base campaign 11 (referred to by a unique campaign ID 10A-1) that corresponds to a unique campaign type 10A-3.

In other words, batch generator module 140 may produce a plurality of training batch data structures 140A, each consisting of a combination of image data structures 130A, having type 10A-3—unique base campaigns 11.

Pertaining to the example above, a first training batch data structure 140A may include a first combination of image data structures 130A of unique base campaign types 10A-3, such as (a) an image data structure 130A where the base campaign type 10A-3 is “bathing suit” (e.g., C2), (b) an image data structure 130A where the base campaign type 10A-3 is “car” (e.g., C3), and (c) an image data structure 130A where the base campaign type 10A-3 is “hotel” (e.g., C6). A second training batch data structure 140A may include (a) an image data structure 130A where the base campaign type 10A-3 is “bathing suit” (e.g., C1), (b) an image data structure 130A where the base campaign type 10A-3 is “car” (e.g., C3), and (c) an image data structure 130A where the base campaign type 10A-3 is “hotel” (e.g., C5), etc.

In some embodiments, batch generator module 140 may produce the plurality of training batch data structures 140A, such that the plurality of batches 140A may include a combinatorically exhaustive representation of all possible campaign type 10A-3 combinations.

According to some embodiments, system 100 may include a training module 180, configured to train ML model 160 to predict a value of a campaign KPI (e.g., produce KPI prediction 100A) based on the plurality of training batch data structures 140A.

For example, during a training stage, training module 180 may receive the one or more training batch data structures 140A, each consisting of a plurality of image data structures 130A, as elaborated herein. Additionally, training module 180 may receive one or more image annotations or label data elements 180A, pertaining to one or more (e.g., each) image data structure 130A of the one or more batch data structures 140A.

As elaborated herein, each image data structure 130A may include, or may correspond to a base campaign 11 (e.g., represented by campaign ID 10A-1 of FIG. 4). In such embodiments, image annotations or labels 180A may be associated with an image data structure 130A, and may be, or may include a value of a target KPI 20 of the base campaign 11 (e.g., having campaign ID 10A-1) of the associated image data structure 130A.

During the training stage, training module 180 may receive (a) the one or more batch data structures 140A as training samples, (b) the image annotations or labels 180A as supervisory data, and (c) the KPI prediction 100A of ML model 160, as feedback data. Training module 180 may thus train ML model 160 based on the received data (a-c), according to any appropriate training algorithm as known in the art, such as a gradient-descent backpropagation algorithm. ML model 160 may be trained so as to produce prediction 100A of a value of a campaign target KPI 20 of the one or more image data structures 130A of the one or more batch data structures 140A.

In a subsequent inference stage, system 100 may receive a sample of campaign data elements 10 pertaining to, or corresponding to at least one new target advertisement campaign 11, for which a prediction 100A of a target KPI value 20 may be required. System 100 may apply trained ML model 160 on the one or more campaign data elements 10 of the new target campaign 11, to produce a prediction 100A of a value of a target KPI 20 of the target advertisement campaign 11.

Currently available methods and systems for analyzing advertisement campaign data elements may employ AB test doctrines and/or randomized advertising experiments, to compare between advertisement campaigns, in an effort to deduce preferred advertising characteristics. For example, currently available methods may employ an advertising experiment to examine a difference between KPIs (e.g., difference in income) as a result of changing a property of an advertisement campaign (e.g., a geography, and advertisement platform, a date, content of an advertisement, etc.). It may be appreciated that such methods may exhibit multiple deficiencies.

For example, advertising experiments require actual, real-world application of changes in the advertisement campaign. Therefore, conducting such experiments inherently compromises the targets of the relevant advertisement campaign.

In another example, deduction of an effect of a change in an advertisement campaign on a target KPI is typically oblivious of underlying latent variables. For example, conducting advertisement campaign having a first advertisement content at a first date or geography, and a changed advertisement content at a second date or geography may not produce sufficient information so as to separate the effect of the change in advertisement content from the change in date or geography.

According to some embodiments, system 100 may include a simulation module 150, which may be associated with ML model 160. Simulation module 150 may utilize the KPI prediction mechanism of ML model 160, as elaborated herein, to replace the need for advertisement campaign experiments. In other words, simulation module 150 may perform real-time “incrementality” prediction of target KPI value 100A, instead of performing an experiment to estimate it.

Additionally, or alternatively, simulation module 150 may utilize prediction model 160 to predict a potential, or simulated target KPI value 100A. In other words, simulation module 150 may apply a plurality of permutations or changes on campaign data elements 10, and apply trained ML model 160 on the permutated campaign data elements 10 to simulate outcome target KPI values 100A corresponding to the permutated campaign data elements 10. The term “simulate” may indicate, in this context, providing an answer to a hypothetical question, such as “what would have happened to a target KPI, if specific changes in campaign data elements 10 were applied”.

Such permutations may include, but are not limited to, a change in campaign properties 10A (e.g., advertiser identification 10A-2, campaign types 10A-3, and the like); a change in campaign characteristics 10B (e.g., campaign geography 10B-1, campaign target population 10B-2, campaign date 10B-3, etc.); and a change in campaign advertisement properties 10E (e.g., advertisement type 10E-1, advertisement platform 10E-2, advertisement content 10E-3, 10E-4, etc.).

According to some embodiments, system 170 may include an analysis module 170, configured to analyze the outcome of KPI predictions 100A, in view of the simulated, permutated campaign data elements 10 of simulation module 150.

In other words, analysis module 170 may collaborate with simulation module 150 to choose an optimal, or suggested advertising strategy, denoted herein as suggested campaign properties 100B.

Suggested campaign properties 100B may be, or may include a data structure (e.g., a table, a linked list, and the like). The suggested campaign properties data structure 100B may represent optimal campaign data elements 10 in relation to a target KPI 20, in a sense that they may produce optimal (e.g., maximal) target KPI 20 values.

For example, suggested campaign properties 100B may indicate an optimal advertisement platform 10E-2, an optimal level of expenditure, an optimal target geography 10B-1, an optimal target population 10B-2, an optimal target date 10B-3, etc.

It may be appreciated that suggested campaign properties 100B may also be used as recommendations for adjusting campaign data elements 10 of active, or existing campaigns 11, in an effort to optimize KPI values of these campaigns 11.

For example, system 100 may produce a suggested campaign properties 100B that may indicate that a specific campaign type 10A-3 (e.g., a campaign 11 for selling umbrellas) should currently produce maximal revenue in a specific, optimal geography (e.g., Michigan). This information may, for example be implicitly learnt by ML model 160, due to other campaigns 11 for commodities in northern United States. System 100 may thus produce a recommendation for an advertiser of umbrellas to target this region so as to gain from that “trend”.

It may be appreciated by a person skilled in the art that system 100 may enable an advertiser or client to gain insight of optimal campaign data elements 10, without changing their business or spending money on advertisement. In other words, embodiments of the invention may provide suggested campaign properties 100B through simulation of theoretical combinations of campaign data elements 10, without performing actual intervention and measuring incrementality of changes, as currently performed in the art.

Additionally, or alternatively, embodiments of the invention may provide a-priori knowledge or insight to the outcome of advertisement campaigns 11, and choose the optimal campaign data elements 10 to run a real-world experiment iteration. After this iteration, system 100 may recalibrate or finetune ML model 160 in order to improve prediction 100A of target KPI value 20. Such iterations may be repeated several times, in an iterative feedback flow, until an optimal set of campaign data elements 10 may be obtained.

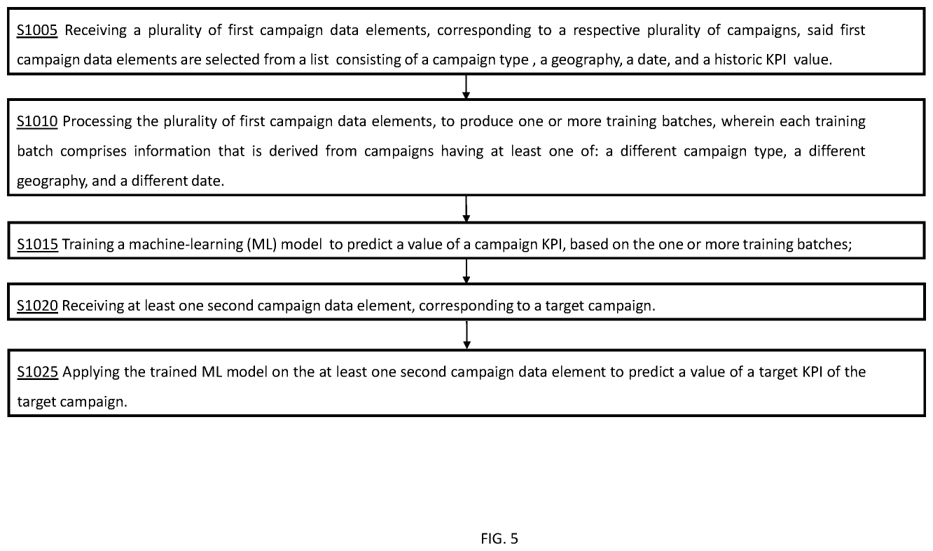

FIG. 5 is a flow diagram, depicting a method of predicting a value of a KPI of a target advertisement campaign 11, according to some embodiments of the invention.

As shown in step S1005, the at least one processor (e.g., element 2 of FIG. 1) may receive a plurality of first campaign data elements (e.g., campaign data elements 10 of FIG. 2), corresponding to a respective plurality of advertisement campaigns 11. The plurality of first campaign data elements 10 may include, for example campaign types (e.g., element 10A-3 of FIG. 2) of the plurality of campaigns 11, geographies (e.g., element 10B-1 of FIG. 2) of the plurality of campaigns 11, dates (e.g., element 10B-3 of FIG. 2) of the plurality of campaigns 11, and a historic KPI values (e.g., elements 10D of FIG. 2) of the plurality of campaigns 11.

As shown in step S1010, the at least one processor 2 may process the plurality of first campaign data elements 10, to produce or generate one or more (e.g., a plurality of) training batch data structures (e.g., batch data structures 140A of FIG. 2).

As elaborated herein (e.g., in relation to FIG. 2 and/or FIG. 4), generation of a batch data structure 140A may be performed in two stages.

In a first stage, the at least one processor 2 may process the plurality of first campaign data elements 10, to generate or create a plurality of image data structures (e.g., image data structures 130A of FIG. 2 and/or FIG. 4), where each image data structure 130A pertains to a specific base campaign 11 (referred to by a specific campaign ID 10A-1) of the plurality of advertisement campaigns 11.

For example, as elaborated herein, image data structure 130A may pertain to a specific base campaign 11 in a sense that it may: (a) include a metadata representation of the base campaign ID (10A-1), and/or (b) include a campaign 11—specific embedding vector 122B of the base campaign 11. Additionally, or alternatively, as elaborated herein, image data structure 130A may include auxiliary information 130B pertaining to a plurality of campaigns 11 other than the base campaign 11.

In a second stage, the at least one processor 2 may select a subset of the plurality of image data structures 130A. The subset of image data structures 130A may represent a selected combination of image data structures 130A, each having a different base campaign type 10A-3. Additionally, or alternatively, the subset of image data structures 130A may represent a selected combination of image data structures 130A, that represent a plurality (e.g., all) campaign types 10A-3 of the advertisement campaign repository. The at least one processor 2 may then compile or concatenate the selected a subset of image data structures 130A to create the training batch data element 140A.

Thus, each training batch data element 140A may include information that is derived from advertisement campaigns 11 (e.g., campaign data elements 10) having at least one of: a different campaign type 10A-3, a different campaign geography 10B-1, and a different campaign date 10B-3.

As shown in step S1015, the at least one processor 2 may collaborate with a training module (e.g., Training module 180 of FIG. 2), to train an ML model (e.g., ML model 160 of FIG. 2). ML model 160 may be trained to predict a value of a campaign KPI (e.g., KPI prediction 100A of FIG. 2), based on the one or more training batches 140A as elaborated herein (e.g., in relation to FIG. 2).

As shown in step S1020, the at least one processor 2 may receive (e.g., during an inference stage or simulation stage), at least one new campaign data element 10, corresponding to a target campaign 11. For example, the at least one new campaign data element 10 may pertain to a new target advertisement campaign 11 (referred herein by a unique campaign ID 10A-1), for which a prediction of a target KPI value 20 is required.

As shown in step S1025, the at least one processor 2 may apply trained ML model 160 on the at least one new campaign data element 10 to predict a value of target KPI 20 of the target campaign 11.

As known in the art of artificial intelligence (AI) and machine learning systems, ML models may perform a process commonly referred to as “transfer learning” between different model configurations. The term “transfer learning” be used herein to refer to storage of knowledge gained while solving one problem, and applying it to a different, but related problem.

For example, embodiments of the invention may implement the transfer learning concept on any one of the aforementioned ML-based models, including for example ML model 160 (e.g., a CNN model), embedding model 121 (e.g., Word2Vec), campaign embedding model 122 (e.g., FastText), Autoencoder model 123, etc.

For example, ML model 160 may use pre-trained models to create embeddings (e.g., FastText 122 for campaign representation, auto-encoder 123 for demographic representation).

In the example of the FastText 122 campaign embeddings, system 100 may (a) used a pre-trained fast-text model (e.g., an “off the shelf” model) that may learn the connections between words included in campaigns 11 (e.g., based on a large corpus of words); and (b) continuously train as a classification problem to get the campaign labels or campaign embedding vector 122B. Embodiments of the invention may take the embedding vector 122B representations (e.g., weights created in the training process, one layer before the final output), and insert the embedding vector 122B representations into ML model 160. Thus, the weights of ML model 160 may continue to be trained on incoming campaign data elements 10 for a new regression task of predicting 100A a value of target KPI 20.

Pertaining to the example of the demographics autoencoder 123: As elaborated herein, system 100 may use autoencoder model 123 to lower the dimension of demographic (e.g., census data, from approximately 200 elements to a representation vector of 8 elements). In other words, demographics autoencoder 123 may be configured to be able to create a lower-dimension model that holds the same information as the original census data. In some embodiments, system 100 may use the weights created in autoencoder model 123 as inputs for the CNN ML model 160, so as to continuously train, or update these weights in order to optimize prediction 100A target KPI 20 value.

In other words, system 100 may implement transfer learning in a sense that one or more of the abovementioned ML models may be initially trained for a first task, and then be integrated into ML model 160 to continuously (e.g., repeatedly over time) optimize the task of predicting 100A the target KPI 20 value.

Embodiments of the invention may include a practical application for predicting a target or selected KPI value of an advertisement campaign 11.

Embodiments of the invention may include an improvement over currently available methods for analyzing campaign parameters by learning the correlation among a plurality of seemingly unrelated advertisement campaigns.

Additionally, embodiments of the invention may perform simulated adaptations to advertisement campaigns, to provide objective, optimal values of campaign data elements 10, without need to perform costly AB tests or randomized experiments, as currently performed in the art.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of predicting, by at least one processor, a value of a key performance indicator (KPI) of a target advertisement campaign, the method comprising:
receiving a plurality of first campaign data elements, corresponding to a respective plurality of campaigns, said first campaign data elements are selected from a list consisting of a campaign type, a geography, a date, and a historic KPI value;
processing the plurality of first campaign data elements, to produce one or more training batches, wherein each training batch comprises information that is derived from campaigns having at least one of: a different campaign type, a different geography, and a different date;
training a machine-learning (ML) model to predict a value of a campaign KPI, based on the one or more training batches;
receiving at least one second campaign data element, corresponding to a target campaign; and
applying the trained ML model on the at least one second campaign data element to predict a value of a target KPI of the target campaign.

2. The method of claim 1, wherein producing a training batch of the one or more training batches comprises:
processing the plurality of first campaign data elements to create a plurality of image data structures, wherein each image data structure pertains to a specific base campaign of the plurality of campaigns;
selecting a subset of the plurality of image data structures; and
concatenating the selected subset of image data structures to create the training batch.

3. The method of claim 2, wherein selecting the subset of image data structures comprises performing combinatorial selection of a subset of the plurality of image data structures, such that each image data structure of the subset has a base campaign that corresponds to a unique campaign type.

4. The method of claim 2, wherein the image data structure represents a correlation between a KPI value of the base campaign and a KPI value of one or more other campaigns of the plurality of campaigns.

5. The method of claim 2, wherein creating an image data structure of the plurality of image data structures comprises:
processing one or more campaign data elements of the plurality of first campaign data elements, pertaining to a base campaign of the plurality of campaigns, to create a campaign embedding vector, representing a content or subject of the base campaign;
processing one or more campaign data elements of the plurality of first campaign data elements, pertaining to one or more other campaigns of the plurality of campaigns, to calculate one or more auxiliary information data elements, representing one or more other campaigns of the plurality of campaigns; and
creating an image data structure that comprises the campaign embedding vector and the one or more auxiliary information data elements.

6. The method of claim 5, wherein each campaign is associated with (i) a respective campaign identifier (ID), and (ii) a campaign performance metric value, and wherein calculating an auxiliary information data element comprises:
grouping the plurality of campaigns based on their respective combination of geography and date;
sorting each group of campaigns based on their respective campaign performance metric values, to obtain a plurality of sorted vectors of campaign IDs; and
applying an embedding ML model on at least one sorted vector of campaign IDs, to obtain at least one respective auxiliary information data element, that represents an embedding of performance metric values of the relevant group of campaigns.

7. The method of claim 5, wherein the plurality of first campaign data elements comprises a plurality of geography data elements, representing a geography of a respective plurality of campaigns, and wherein calculating an auxiliary information data element comprises:
receiving a first version of a demographic data element corresponding to a geography data element of the plurality of geography data elements, wherein said first version of the demographic data element is characterized by a first representation dimension;
applying an ML module on the geography data element, to obtain an auxiliary information data element that is a second version of the geography data element, having a second, reduced representation dimension.

8. The method of claim 1, further comprising:
applying a plurality of permutations on the campaign data elements;
applying the trained ML model on the permutated campaign data elements, to simulate outcome target KPI values corresponding to the permutated campaign data elements; and
analyzing the simulated outcome of KPI predictions, in view of the permutated campaign data elements, to produce a suggested campaign properties data structure, representing optimal campaign data elements in relation to a target KPI.

9. The method of claim 1, wherein the permutations are selected from a list consisting of a change in: campaign properties, advertiser identification, campaign types, campaign characteristics, campaign geography, target population, campaign date, campaign advertisement properties, advertisement type, advertisement platform, advertisement content, advertisement text content.

10. A system for predicting a value of a key performance indicator (KPI) of a target advertisement campaign, the system comprising a non-transitory memory device, wherein modules of instruction code are stored, and at least one processor associated with the memory device, and configured to execute the modules of instruction code, whereupon execution of said modules of instruction code, the at least one processor is configured to:
receive a plurality of first campaign data elements, corresponding to a respective plurality of campaigns, said first campaign data elements are selected from a list consisting of a campaign type, a geography, a date, and a historic KPI value;
process the plurality of first campaign data elements, to produce one or more training batches, wherein each training batch comprises information that is derived from campaigns having at least one of: a different campaign type, a different geography, and a different date;
train a machine-learning (ML) model to predict a value of a campaign KPI, based on the one or more training batches;
receive at least one second campaign data element, corresponding to a target campaign; and
apply the trained ML model on the at least one second campaign data element to predict a value of a target KPI of the target campaign.

11. The system of claim 10, wherein the at least one processor is configured to produce a training batch of the one or more training batches by:
processing the plurality of first campaign data elements to create a plurality of image data structures, wherein each image data structure pertains to a specific base campaign of the plurality of campaigns;
selecting a subset of the plurality of image data structures; and
concatenating the selected subset of image data structures to create the training batch.

12. The system of claim 11, wherein the at least one processor is configured to select the subset of image data structures by performing combinatorial selection of a subset of the plurality of image data structures, such that each image data structure of the subset has a base campaign that corresponds to a unique campaign type.

13. The system of claim 11, wherein the image data structure represents a correlation between a KPI value of the base campaign and a KPI value of one or more other campaigns of the plurality of campaigns.

14. The system of claim 11, wherein the at least one processor is configured to create an image data structure of the plurality of image data structures by:
processing one or more campaign data elements of the plurality of first campaign data elements, pertaining to a base campaign of the plurality of campaigns, to create a campaign embedding vector, representing a content or subject of the base campaign;
processing one or more campaign data elements of the plurality of first campaign data elements, pertaining to one or more other campaigns of the plurality of campaigns, to calculate one or more auxiliary information data elements, representing one or more other campaigns of the plurality of campaigns; and
creating an image data structure that comprises the campaign embedding vector and the one or more auxiliary information data elements.

15. The system of claim 14, wherein each campaign is associated with (i) a respective campaign identifier (ID), and (ii) a campaign performance metric value, and wherein the at least one processor is configured to calculate an auxiliary information data element by:
grouping the plurality of campaigns based on their respective combination of geography and date;
sorting each group of campaigns based on their respective campaign performance metric values, to obtain a plurality of sorted vectors of campaign IDs; and
applying an embedding ML model on at least one sorted vector of campaign IDs, to obtain at least one respective auxiliary information data element, that represents an embedding of performance metric values of the relevant group of campaigns.

16. The system of claim 14, wherein the plurality of first campaign data elements comprises a plurality of geography data elements, representing a geography of a respective plurality of campaigns, and wherein the at least one processor is configured to calculate an auxiliary information data element by:
receiving a first version of a demographic data element corresponding to a geography data element of the plurality of geography data elements, wherein said first version of the demographic data element is characterized by a first representation dimension;
applying an ML module on the geography data element, to obtain an auxiliary information data element that is a second version of the geography data element, having a second, reduced representation dimension.

17. The system of claim 10, the at least one processor is further configured to:
apply a plurality of permutations on the campaign data elements;
apply the trained ML model on the permutated campaign data elements, to simulate outcome target KPI values corresponding to the permutated campaign data elements; and
analyze the simulated outcome of KPI predictions, in view of the permutated campaign data elements, to produce a suggested campaign properties data structure, representing optimal campaign data elements in relation to a target KPI.

18. The system of claim 10, wherein the permutations are selected from a list consisting of a change in: campaign properties, advertiser identification, campaign types, campaign characteristics, campaign geography, target population, campaign date, campaign advertisement properties, advertisement type, advertisement platform, advertisement content, advertisement text content.
